(19) United States
(12) Patent Application Publication
(10) Pub. No.: US 2013/0074406 A1
(43) Pub. Date: Mar. 28, 2013

(54) Planter Box for Mounting to a Structure and Planter Box Assembly

(71) Applicant: Christopher John Allison, New South Wales (AU)

(72) Inventor: Christopher John Allison, New South Wales (AU)

(21) Appl. No.: 13/624,522

(22) Filed: Sep. 21, 2012

(30) Foreign Application Priority Data
Sep. 22, 2011 (AU) 2011903905

(51) Int. Cl. A01G 9/02

(52) U.S. Cl. 47/66.7; 47/65.5

(57) ABSTRACT

A planter box for mounting to a structure includes a box body comprising side walls and a respective attachment means extending laterally relative to each side wall, each attachment means adapted for mounting the planter box to the structure. Also provided is a method of mounting a planter box to a structure, the planter box comprising a body having side walls, attachment means extending laterally relative to each side wall, a rear wall, and at least one support formation extending generally rearwardly relative to the rear wall. The method includes the steps of disposing the planter box adjacent the structure such that the at least one support formation supports the planter box on the structure and attaching the attachment means to the structure to mount the planter box to the structure.

### CROSS-REFERENCE TO RELATED APPLICATIONS

This application claims the priority, under 35 U.S.C. §§119 and 371, of Australian patent application No. 2011903905, filed Sep. 22, 2011; the prior application is herewith incorporated by reference in its entirety.

### STATEMENT REGARDING FEDERALLY SPONSORED RESEARCH OR DEVELOPMENT

Not Applicable

### FIELD OF THE INVENTION

The present invention relates to a planter box for mounting to a structure such as a wall or a bracket assembly, and a planter box assembly.

The invention has been developed primarily for use in horticulture and will be described hereinafter with reference to this application. However, it will be appreciated that the invention is not limited to this particular field of use.

### BACKGROUND OF THE INVENTION

Various assemblies are available for mounting planter boxes to a wall. These assemblies however have various different disadvantages, such as small capacity in terms of plants supported, poor appearance or difficult installation.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

Thus, a need exists to overcome the problems with the prior art systems, designs, and processes as discussed above.

### SUMMARY OF THE INVENTION

According to a first aspect, the present invention provides a planter box for mounting to a structure, the planter box comprising:
a box body comprising side walls; and
a respective attachment means extending laterally relative to each side wall, each attachment means adapted for mounting the planter box to the structure.

Preferably, each attachment means extends from its respective side wall.

Preferably, the planter box further comprises a rear wall, and wherein each attachment means is adjacent the rear wall.

Advantageously, these locate the attachment means in an effective manner.

Alternatively, each attachment means can extend from the rear wall.

Advantageously, this can be preferred if the planter box is desired to be spaced from the structure when mounted.

Preferably, each attachment means is substantially aligned with the rear wall.

Preferably, each attachment means comprises at least one web.

Advantageously, this provides an attachment means which can be made integral with the planter box.

Preferably, the planter box comprises at least two spaced webs extending laterally relative to each side wall.

Advantageously, this provides numerous mounting points to ensure secure mounting.

Preferably, the at least two spaced webs along each side wall are spaced generally vertically from each other.

Advantageously, this distributes the mounting points along the planter box.

Preferably, the attachment means of one side wall are offset vertically from the attachment means of the other side wall.

Advantageously, this allows adjacent planter boxes to be disposed close to each other.

Preferably, each web includes at least one reinforcement flange.

Advantageously, this ensure the flanges are secured to the planter box.

Preferably, each web includes at least one aperture for fastening means.

Preferably, the planter box further comprises a rear wall and at least one support formation extending generally rearwardly relative to the rear wall, the at least one support formation adapted to support the planter box to the structure in use.

Advantageously, this allows the planter box to be supported during mounting thereof which allows for easy installation.

Preferably, the at least one support formation comprises at least one flange extending across a rear surface of the rear wall.

Preferably, the at least one flange extends substantially horizontally across the rear surface of the rear wall.

Advantageously, these features provide good support for the planter box during mounting thereof.

Preferably, the at least one flange projects substantially perpendicularly from the rear surface of the rear wall.

Advantageously, this provides a simple but effective support formation.

Preferably, the at least one flange extends across the entire width of the rear surface

Preferably, the at least one flange comprises a top flange extending adjacent a top edge of the rear wall.

Advantageously, this provides a flange which can extend along an upper surface of the structure.

Preferably, the at least one flange comprises a plurality of flanges spaced along the rear surface of the rear wall.

Preferably, the plurality of flanges are spaced vertically from each other along the rear surface of the rear wall.

Advantageously, these distribute the flanges along the rear wall to provide support for the planter box along the height thereof.

Preferably, each flange is adjacent a respective attachment means.

Advantageously, this ensures the attachment means can be attached to the structure section supporting the flange.

Preferably, the attachment means of adjacent flanges extend from opposite side walls of the planter box.

Advantageously, this allows adjacent planter boxes to be disposed close to each other.

Preferably, the planter box comprises a generally hollow rectangular prism body.

Preferably, the planter box comprises a front wall having at least one aperture.

Advantageously, plants can be planted through the front wall apertures.

Preferably, the at least one aperture is generally rectangular.

Preferably, the at least one aperture is a plurality of spaced apertures which are generally arranged in a grid array.

Advantageously, these provide a set of apertures which allows plants to cover the front wall.

Preferably, at least one of the side walls comprises at least one aperture.

Advantageously, plants can be planted through the side wall aperture(s).

Preferably, the front wall comprises at least one flange extending across a front surface thereof.

Preferably, the side walls comprise at least one flange extending across an external surface thereof.

Advantageously, these flanges contribute to the stiffness of the planter box.

Preferably, the planter box comprises an upper opening.

Preferably, the planter box comprises a bottom wall having a plurality of drainage apertures.

The present invention in another aspect provides a planter box assembly comprising at least one planter box according to the above and a bracket assembly, the bracket assembly comprising:
at least one mount member for mounting to a structure, the body comprising at least one attachment member to which each attachment means of the at least one planter box can be attached for mounting the at least one planter box to the structure.

Advantageously, the bracket assembly provides the at least one attachment member to which the planter boxes can be attached,

Preferably, at least one mount member of the bracket assembly comprises at least one plate for mounting to the structure.

Advantageously, this provides a simple but effective means of mounting the bracket assembly to the structure.

Preferably, the at least one mount member comprises at least first and second spaced plates.

Alternatively, the at least one mount member can comprise at least first, second and third spaced plates.

Preferably, each plate comprises a planar attachment portion.

Alternatively, each plate comprises an attachment portion which is disposed generally perpendicularly relative to the section of the body.

Preferably, the attachment portion of each plate is disposed generally forwardly relative to the section of the body.

Alternatively, the attachment portion of each plate is disposed generally rearwardly relative to the section of the body.

Preferably, the attachment portion of each plate includes at least one mounting aperture.

Advantageously, this allows the plates to be mounted to facing surfaces of spaced structures or walls.

Preferably, the at least one attachment member is removably attachable to the at least one mount member.

Advantageously, this simplifies transport and assembly of the bracket assembly.

Preferably, the at least one attachment member comprises at least one bar.

Advantageously, this provides an effective section to which the planter boxes can be attached.

Preferably, the at least one attachment member comprises a plurality of spaced bars.

Preferably, the plurality of spaced bars extend substantially horizontally.

Preferably, the plurality of spaced bars are spaced vertically from each other.

Advantageously, these provide bars which can support the flanges in the rear wall of the planter box.

Preferably, each planter box comprises a rear wall and a plurality of support formations extending generally rearwardly relative to the rear wall, wherein the plurality of spaced bars are adapted to support the support formations.

Preferably, the plurality of support formations are flanges extending substantially horizontally across the rear wall.

Advantageously, the flanges provide a big area which is supported by the bars.

The present invention also provides a structure comprising the planter box of the above mounted thereon.

The present invention also provides a structure comprising the planter box assembly of the above mounted thereon.

The present invention also provides a planter box for mounting to a structure, the planter box comprising:
a body comprising attachment means adapted for mounting the planter box to the structure, a rear wall and at least one support formation extending generally rearwardly relative to the rear wall, the at least one support formation adapted to support the planter box on the structure in use.

Advantageously, the support formations allow the planter boxes to be supported during mounting, which eases installation.

Preferably, the planter box further comprises side walls and a respective attachment means extending laterally relative to each side wall.

Advantageously, this provides attachment means which can be easily accessed.

Preferably, at least one of the side walls comprises at least one aperture.

Advantageously, plants can be planted through the side wall aperture(s).

Preferably, the at least one support formation comprises at least one flange extending across a rear surface of the rear wall.

Preferably, the at least one flange projects substantially perpendicularly from the rear surface of the rear wall.

Advantageously, these provides a simple but effective support formation.

Preferably, the at least one flange comprises a top flange extending adjacent a top edge of the rear wall.

Advantageously, this provides a flange which can extend along an upper surface of the structure.

Preferably, the at least one flange comprises a plurality of flanges spaced along the rear surface of the rear wall.

Preferably, the plurality of flanges are spaced vertically from each other along the rear surface of the rear wall.

Advantageously, these distribute the flanges along the rear wall to provide support for the planter box along the height thereof.

The present invention in another aspect provides a method of mounting a planter box to a structure, the planter box comprising side walls and a respective attachment means extending laterally relative to each side wall, the method comprising:
disposing the planter box adjacent the structure; and
attaching the attachment means to the structure to mount the planter box to the structure.

The present invention in another aspect provides a method of mounting at least two planter boxes to a structure, each planter box comprising side walls and a respective attachment means extending laterally relative to each side wall, wherein the attachment means of one side wall are offset vertically from the attachment means of the other side wall, the method comprising:
disposing the first planter box adjacent the structure;
attaching the attachment means of the first planter box to the structure to mount the first planter box to the structure;
disposing the second planter box adjacent the first planter box with the attachment means of adjacent side walls being generally located along a line; and
attaching the attachment means of the second planter box to the structure to mount the second planter box to the structure.

Advantageously, this allows adjacent planter boxes to be mounted close to each other.

The present invention in another aspect provides a method of mounting a planter box to a structure, the planter box comprising a body having attachment means adapted for mounting the planter box to the structure, a rear wall and at least one support formation extending generally rearwardly relative to the rear wall, the method comprising:
disposing the planter box adjacent the structure such that the at least one support formation supports the planter box on the structure; and
attaching the attachment means to the structure to mount the planter box to the structure.

The present invention in another aspect provides a method of mounting a planter box to a structure, the planter box comprising a body having side walls, attachment means extending laterally relative to each side wall, a rear wall, and at least one support formation extending generally rearwardly relative to the rear wall, the method comprising:
disposing the planter box adjacent the structure such that the at least one support formation supports the planter box on the structure; and
attaching the attachment means to the structure to mount the planter box to the structure.

Advantageously, the support formations allow the planter boxes to be supported during mounting, which eases installation.

Preferably, the structure is a wall or a bracket assembly.

Although the invention is illustrated and described herein as embodied in a planter box for mounting to a structure such as a wall or a bracket assembly, and a planter box assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a perspective view of a planter box in accordance with a preferred embodiment of the present invention;

FIG. 2 shows (i) front view, (ii) rear view, (iii) side view, (iv) top view and (v) bottom view of the planter box of FIG. 1;

FIG. 3 is a front view of a bracket assembly in accordance with a preferred embodiment of the present invention;

FIG. 4 shows (i) front view, (ii) side view and (iii) top view of the bracket assembly of FIG. 3 mounted to a wall;

FIG. 5 shows (i) front view and (ii) side view of two assembled planter box assemblies comprising two of the bracket assemblies of FIGS. 3 and 4 and a plurality of the planter boxes of FIGS. 1 and 2;

FIG. 6 shows six of the planter boxes of FIG. 5 in their mounted arrangement;

FIG. 7 is a side view of a planter box in accordance with another preferred embodiment of the present invention;

FIG. 8 shows (i) front view, (ii) side view and (iii) top view of a bracket assembly in accordance with another preferred embodiment of the present invention mounted to a wall; and

FIG. 9 is a top view of an alternative mounting of the bracket assembly of FIG. 8 to a pair of spaced structures.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

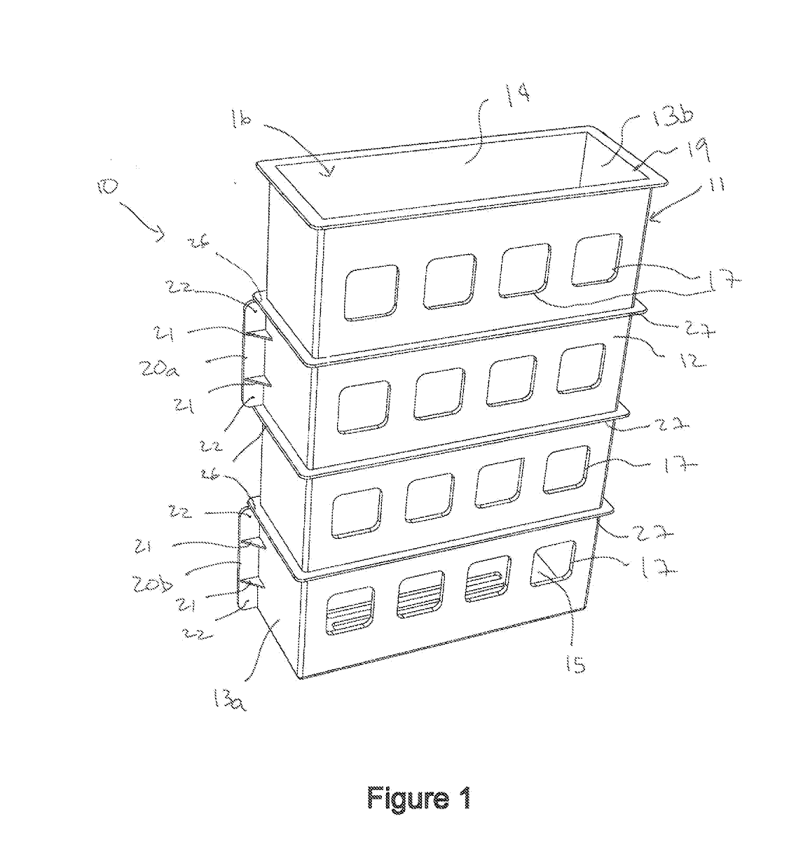

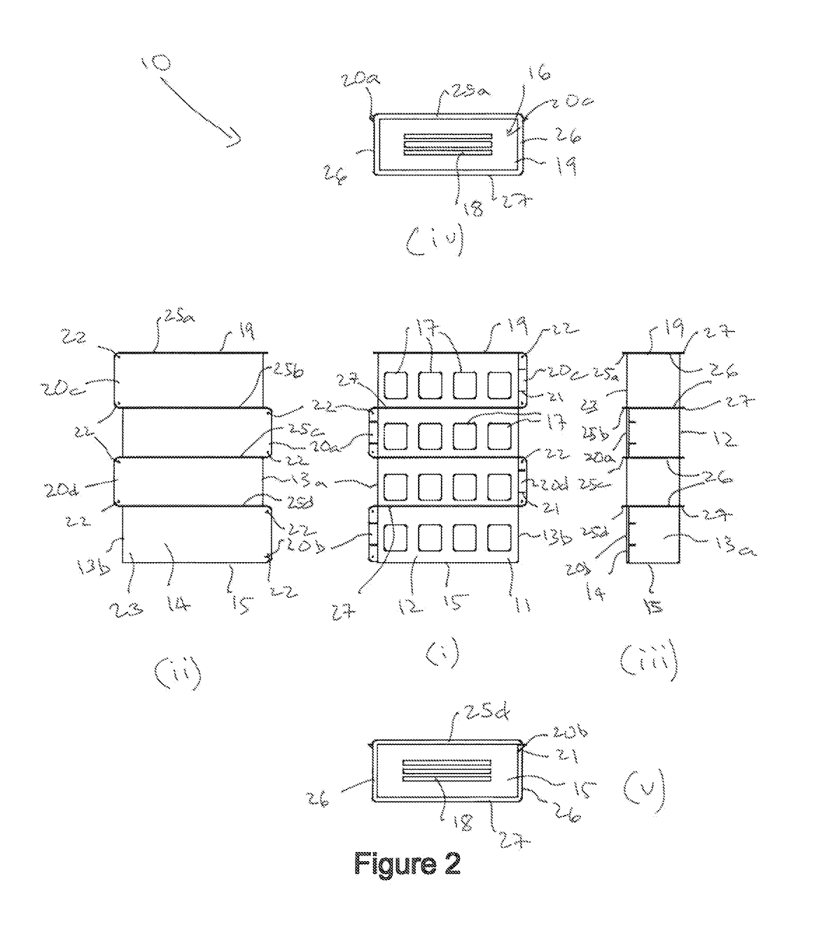

Described now are exemplary embodiments of the present invention. Referring now to the figures of the drawings in detail and first, particularly to FIGS. 1 and 2, there is shown a first exemplary embodiment of a planter box 10 according to the preferred embodiment of the present invention. The planter box 10 comprises a hollow generally rectangular prism body 11 having a front wall 12, side walls 13a and 13b, a rear wall 14, and a bottom wall 15. Upper edges 19 of the front, side and rear walls 12 to 14 define an upper opening 16 of the planter box 10.

The front wall 12 includes a plurality of spaced generally rectangular apertures 17. The apertures 17 are generally arranged in a grid array. In this embodiment, the front wall 12 includes sixteen apertures 17 arranged in a 4×4 grid array. The bottom wall 15 includes a plurality of generally elongated rectangular apertures 18, which function as drainage apertures.

The planter box 10 includes an attachment means extending laterally relative to each of the side walls 13a and 13b, each attachment means comprising a web 20. Each of the side walls 13a and 13b includes two webs 20. The side wall 13a includes webs 20a and 20b, and the side wall 13b includes webs 20c and 20d, with the webs 20 in each side being spaced vertically from each other. Each web 20 extends from its respective side wall 13a, 13b and is generally aligned with the rear wall 14. The webs 20a, 20b of the side wall 13a are offset vertically from the webs 20c, 20d of the other side wall 13b. In the embodiment for example, the web 20c on the side wall 13b extends from the upper edge 19, and the web 20a on the opposite side wall 13a extends from a height slightly lower than a lowest edge of the web 20c. Similarly, the web 20d extends from a slightly height lower than a lowest edge of the web 20a, and the web 20b extends from a height slightly lower than a lowest edge of the web 20d to the bottom wall 15. Each web 20 includes two spaced reinforcement flanges 21 extending from its respective side wall 13a, 13b. Each web 20 also includes two spaced apertures 22 for fastening means to extend therethrough, which in the embodiment are screws.

The planter box 10 also comprises support formations which extend generally outwardly from a rear surface 23 of the rear wall 14, which in the embodiment are four spaced flanges 25. The flanges 25 extend substantially horizontally across the entire width of the rear surface 23. The flanges 25 project generally perpendicularly from the rear surface 23 of the rear wall 14. That is, the flanges 25 extend in a direction generally away from the front wall 12.

Each flange 25 is adjacent a top edge of a respective corresponding web 20. In the embodiment, flange 25a is adjacent a top edge of web 20c, flange 25b is adjacent a top edge of web 20a, flange 25c is adjacent a top edge of web 20d, and flange 25d is adjacent a top edge of web 20b. Each flange 25 also extends beyond the side walls 13a and 13b.

In the embodiment, the planter box 10 also includes side wall flanges 26 and front wall flanges 27, which are joined to each other and to the rear wall flanges 25. These side wall flanges 26 and front wall flanges 27 are spaced, horizontal and aligned with a respective rear wall flange 25. The webs 20c, 20a and 20d thus respectively extend between adjacent side flanges 26, with the web 20b extending between the lowest side flange 26 and the bottom wall 15. The side wall flanges 26 and front wall flanges 27 contribute to the rigidity and unique look of the planter box 10.

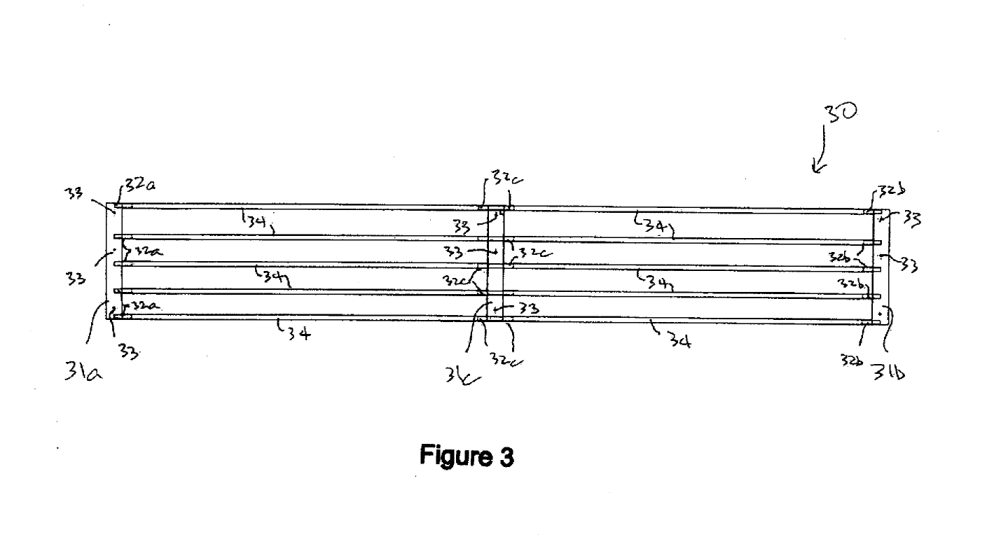

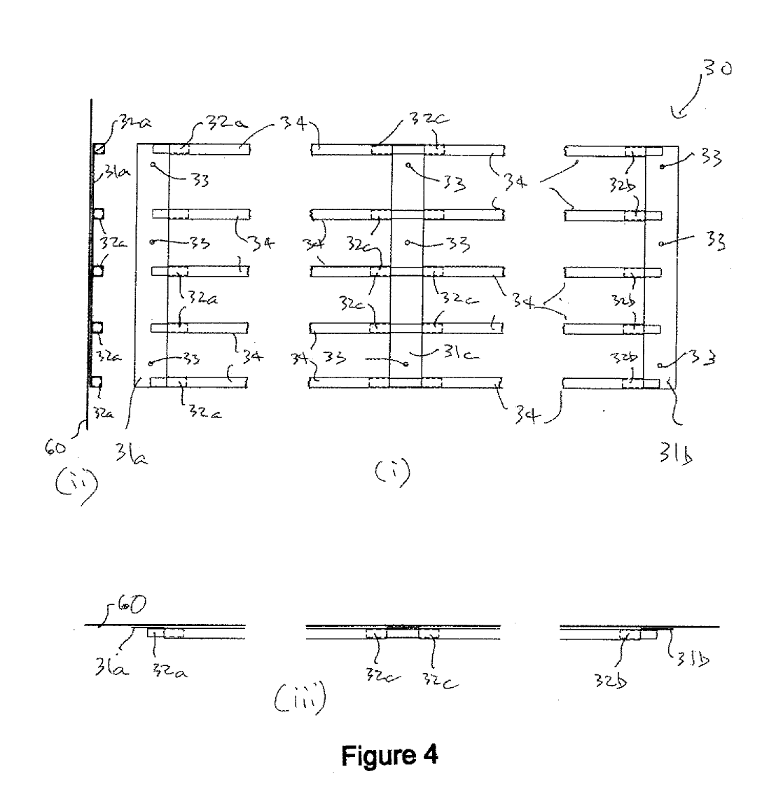

FIGS. 3 and 4 show a bracket assembly 30 in accordance with a preferred embodiment of the present invention. The bracket assembly 30 in some embodiments will comprise the structure to which the planter box 10 is mounted.

The bracket assembly 30 comprises mount members in the form of a first end plate 31a, a second end plate 31b and a third middle plate 31c. The plates 31a to 31c are generally elongated rectangular plates which are spaced from each other, with the middle plate 31c disposed between the end plates 31a and 31b. The plates 31a to 31c both include five spaced attachment members 32, which in the embodiment are short rods. The attachment rods 32 in each plate 31a to 31c are generally parallel to each other and generally parallel to their respective plate 31a to 31c. The attachment rods 32a and 32b of the end plates 31a and 31b extend in a direction generally outwardly and perpendicularly relative to one lateral edge thereof. The attachment rods 32c of the middle plate 31c extend in a direction generally outwardly and perpendicularly relative to both lateral edges thereof. Each of the plates 31a to 31c includes apertures 33 for mounting to a wall.

The bracket assembly 30 comprises ten bars 34 which are respectively attached between two of the attachment rods 32a to 32c of the plates 31a to 31c. Each bar 34 is a hollow tube having open ends into which a respective attachment rod 32 of two plates 31 is inserted. Five spaced bars 34 thus extend between the end plate 31a and the middle plate 31c, and five spaced bars 34 extend between the middle plate 31c and the end plate 31b. The bars 34 can be attached to the respective attachment rods 32 by suitable means, such as screws, or the bars 34 can be retained in place between the plates 31 without such attachment by mounting the plates 31 by a suitable distance to each other. The attachment rods 32 are spaced and the bars 34 are dimensioned such that the distance between upper surfaces of the bars 34 are substantially equal to the distance between lower surfaces of the flanges 25 of the planter box rear surface 23.

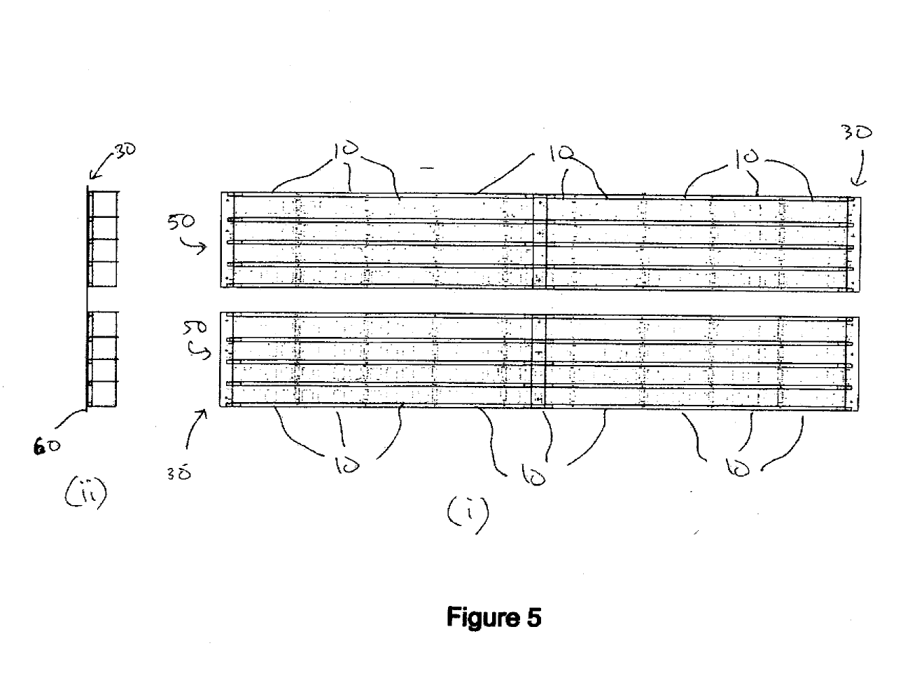

FIG. 5 shows two planter box assemblies 50, each comprising one bracket assembly 30 mounted to a wall 60 and nine planter boxes 10 mounted to each bracket assembly 30. In this embodiment, the planter box assemblies 50 are spaced vertically. The wall 60 is a wall of a structure such as a building or a fence.

In forming each planter box assembly 50, the bracket assembly 30 is firstly mounted by the installer to the wall 60. The plates 31 are mounted to the wall 60 via suitable mounting means such as anchor bolts or screws extending through the apertures 33. The plates 31 are disposed relative to each other such that they are generally aligned and the bars 34 extend substantially horizontally.

A first planter box 10 is then mounted to the bracket assembly 30. The flanges 25 in the rear wall 14 of the planter box 10 are respectively located on top of the bars 34, with the flange 25a located on top of the top bar 34. As such, the installer can generally push on the planter box 10 toward the wall 60, with most of the weight of the planter box 10 generally supported by the bars 34 during mounting thereof. The webs 20 of the planter box 10 are then attached to the bars 34 by suitable means, such as self-tapping screws, extending through the upper aperture 22 of each web 20. As the webs 20 extend laterally relative to each side wall 13, the installer can easily access the apertures 22.

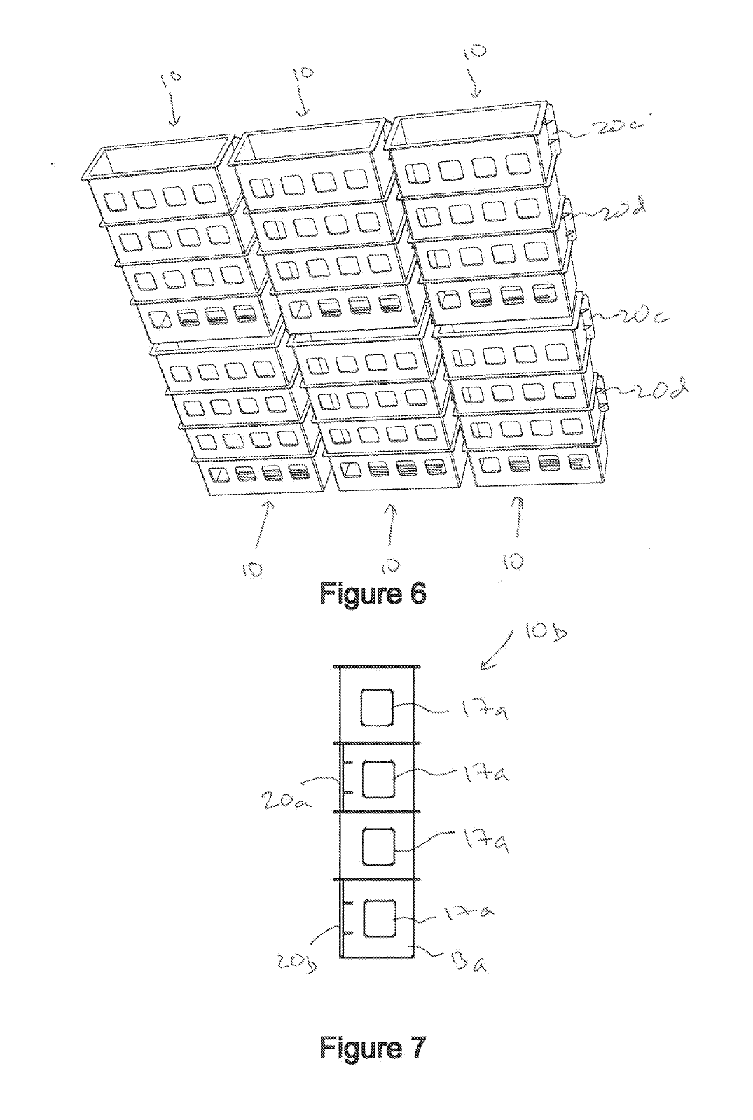

A second planter box 10 is then mounted to the bracket assembly 30 in a similar manner. As the webs 20a, 20b of the side wall 13a are offset vertically from the webs 20c, 20d of the other side wall 13b, the web 20a of a second planter box 10 can be located in the space between the webs 20c, 20d of the mounted first planter box 10 and the web 20b of the second planter box 10 can be located below the web 20d of the first planter box 10. The webs 20 of adjacent side walls are thus generally located along a vertical line. This allows the adjacent planter boxes 10 to be disposed close to each other. Further, as the webs 20 extend laterally relative to each side wall 13, the installer can access the webs 20 between the side walls 13 of adjacent planter boxes 10, for example via an extended drill bit. This allows the planter boxes 10 to be mounted side by side close to each other. FIG. 6 for example shows six of the planter boxes 10 in the assemblies 50 shown in FIG. 5 in their mounted arrangement.

In use, each planter box 10 is lined with a geotextile fabric and then filled with soil contained in a plastics material bag. Slits are then formed in the geotextile fabric and the plastics materials bag through the apertures 17 in the front wall 12. Plants are then planted through the apertures 17 as desired.

In a broad form of the present invention, the planter box 10 can be attached directly to a wall via suitable fasteners extending through the apertures 22 of the webs 20. For example, the apertures 22 can be enlarged to receive anchor bolts therethrough. In this embodiment, the bracket assembly will not be required. The flanges in the rear wall may also be omitted.

In another broad form, the present invention provides a planter box comprising: a body having attachment means adapted for mounting the planter box to a structure, a rear wall and at least one support formation extending generally rearwardly relative to the rear wall, the at least one support formation adapted to support the planter box to the structure during mounting of the planter box to the structure.

In this alternative aspect, the at least one support formation can comprise the flanges for supporting the planter box during mounting thereof, either to a wall or to the bracket assembly. The attachment means can be any suitable attachment means and do not have to be the webs described above. For example, the attachment means can be apertures formed in the rear wall which are accessible through the front wall apertures.

It can be seen that the present invention provides a planter box and a planter box assembly which provides a number of advantages. Each planter box is able to carry a large number of plants which will generally cover the planter box front wall in use. As such, it is possible to substantially cover a wall with plants, with the planter boxes and/or the planter box assembly being substantially hidden. As each planter box can be supported via the rear wall flanges during mounting thereof, it is also possible to fill the planter boxes with soil and plants prior to mounting to the bracket assembly. Having the webs extend laterally allows easy installation of the planter boxes, particularly side by side close installation of a number of the planter boxes.

In the embodiment, the planter box is made from plastics material and the bracket assembly is made from metal. However, these can be made from other suitable material as desired.

It will also be apparent to skilled persons that modifications can be made to the above embodiments. For example, the bracket assembly can be modified such that the bars are spaced from the wall when mounted if desired. Also, the number of flanges in the rear wall of the planter box and the number of bars in the bracket assembly can be increased or decreased as desired. The rear wall flanges can also be replaced with other suitable formations such as spaced protrusions, as long as they can support the planter boxes as desired. The bars can also be made integral with the plates, and the length of the bars can be increased or decreased as desired. In other embodiments, the planter box attachment means can project from the rear wall but extend laterally relative to the side walls. It is also apparent that the middle bracket can be omitted from the bracket assembly with the bars extending between the end plates. The planter box can also include webs extending from its upper edge or from its lower edge.

FIG. 7 shows a modified planter box 10b, which includes apertures 17a formed in the side wall 13a. The other side wall 13b can similarly include the apertures 17a. Thus, plants can be planted through the side walls 13a and 13b, particularly if the planter box 10b is not adjacent another planter box or structure.

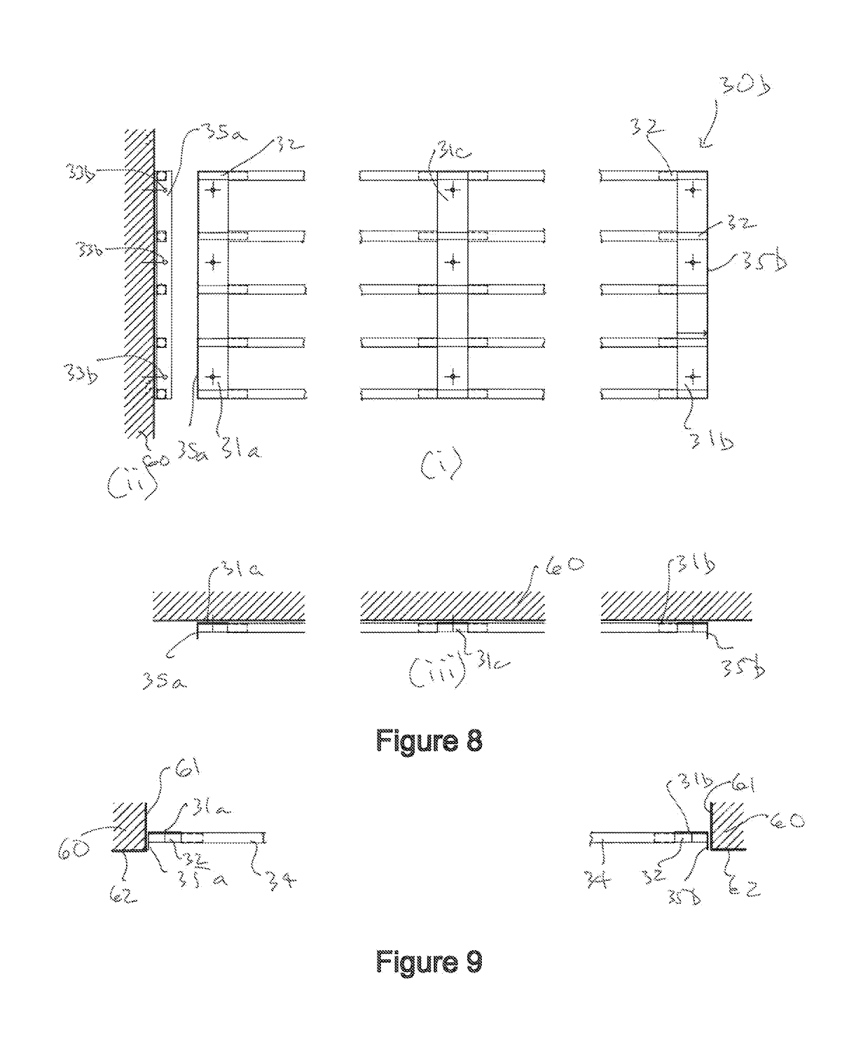

FIG. 8 shows a bracket assembly 30b, which is a modification of the bracket assembly 30. In this embodiment, the end plates 31a and 31b respectively include second attachment portions 35a and 35b which are angled by 90° forwardly relative to the longitudinal direction of the attachment rods 32. The attachment rods 32 in this embodiment are lengthened to extend to the second attachment portions 35a and 35b. The bracket assembly 30b can be attached to a wall 60 in a similar manner as the bracket assembly 30.

The second attachment portions 35a and 35b of the bracket assembly 30b also include attachment apertures 33b. This allows the plates 31a and 31b to be mounted to facing surfaces 61 of posts or walls 60, with the bars 34 extending generally between front surfaces 62 of the posts or walls 60. This also allows the plates 31a and 31b to be mounted generally flush with the front surfaces 62 of such posts or walls 60. Alternatively, the second attachment portions 35a and 35b can be angled by 90° rearwardly relative to the longitudinal direction of the attachment rods 32, which will allow the bars 34 to be positioned more forwardly relative to the front surfaces 62. This embodiment thus allows a planter box assembly to be mounted between spaced structures, such as spaced posts or walls. The middle plate 31c is not required in such an assembly.

The planter box can be dimensioned as desired. For commercial installations, the planter boxes can be made durable and adapted to carry a large number of plants. For lighter installations, the planter boxes can be made lighter by having shorter dimensions, less depth and thinner wall thicknesses.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the horticultural and gardening industries.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A planter box for mounting to a structure, the planter box comprising:
a box body comprising side walls; and
a respective attachment means extending laterally relative to each side wall, each attachment means adapted for mounting the planter box to the structure.

2. The planter box of claim 1 wherein the box body comprises a rear wall, each attachment means extending from its respective side wall and substantially aligned with the rear wall.

3. The planter box of claim 1 wherein each attachment means comprises at least one web having at least one aperture for fastening means.

4. The planter box of claim 3 wherein the planter box comprises at least two spaced webs extending laterally relative to each side wall, the at least two spaced webs along each side wall being spaced generally vertically from each other.

5. The planter box of claim 1 wherein the attachment means of one side wall are offset vertically from the attachment means of the other side wall.

6. The planter box of claim 1 wherein the box body comprises a rear wall, the planter box further comprising at least one support formation extending generally rearwardly relative to the rear wall, the at least one support formation adapted to support the planter box to the structure in use.

7. The planter box of claim 6 wherein the at least one support formation comprises at least one flange extending substantially horizontally across a rear surface of the rear and projecting substantially perpendicularly from the rear surface of the rear wall.

8. The planter box of claim 7 wherein the at least one flange comprises a top flange extending adjacent a top edge of the rear wall.

9. The planter box of claim 7 wherein the at least one flange comprises a plurality of flanges spaced vertically from each other along the rear surface of the rear wall.

10. The planter box of claim 7 wherein each flange is adjacent a respective attachment means and the attachment means of adjacent flanges extend from opposite side walls of the planter box.

11. The planter box of claim 1 comprising a front wall having a plurality of spaced apertures.

12. The planter box of claim 1 comprising a generally hollow rectangular prism body having an upper opening and a bottom wall with a plurality of drainage apertures.

13. The planter box of claim 1, wherein at least one of the side walls comprises at least one aperture.

14. A planter box assembly comprising at least one planter box according to claim 1 and a bracket assembly, the bracket assembly comprising:
at least one mount member for mounting to a structure; and
at least one attachment member to which each attachment means of the at least one planter box can be attached for mounting the at least one planter box to the structure.

15. The planter box assembly of claim 14 wherein the at least one mount member comprises at least one plate for mounting to the structure.

16. The planter box assembly of claim 15 wherein each plate comprises an attachment portion which is disposed generally perpendicularly relative to the at least one attachment member.

17. The planter box assembly of claim 14 wherein the at least one attachment member is removably attachable to the at least one mount member.

18. The planter box assembly of claim 17 wherein the at least one attachment member comprises a plurality of vertically spaced bars.

19. The planter box assembly of claim 18 wherein each planter box comprises a rear wall and a plurality of support formations extending generally rearwardly relative to the rear wall, wherein the plurality of spaced bars are adapted to support the support formations.

20. A method of mounting a planter box to a structure, the planter box comprising a body having side walls, attachment means extending laterally relative to each side wall, a rear wall, and at least one support formation extending generally rearwardly relative to the rear wall, the method comprising:
disposing the planter box adjacent the structure such that the at least one support formation supports the planter box on the structure; and
attaching the attachment means to the structure to mount the planter box to the structure.
